(19) United States
(12) Patent Application Publication
(10) Pub. No.: US 2019/0204198 A1
(43) Pub. Date: Jul. 4, 2019

(54) WETTABILITY TESTER

(71) Applicants: KABUSHIKI KAISHA MAKABE GIKEN, Sendai-shi (JP); TOHOKU UNIVERSITY, Sendai-shi (JP)

(72) Inventors: Eiichi MAKABE, Sendai-shi (JP); Yasuyuki FUKUDA, Sendai-shi (JP); Haruka KIDACHI, Sendai-shi (JP); Kenji AMIYA, Sendai-shi (JP)

(21) Appl. No.: 16/233,821

(22) Filed: Dec. 27, 2018

(30) Foreign Application Priority Data
Dec. 28, 2017 (JP) 2017254555

(51) Int. Cl. G01N 11/14; G01N 13/02; G01N 25/38; G01N 1/44

(52) U.S. Cl. CPC G01N 11/14; G01N 13/02; G01N 2011/002; G01N 1/44; G01N 2013/0225; G01N 25/38

(57) ABSTRACT

There is provided a wettability tester using a test material in a molten state, including: a chamber; a vacuum exhaust section exhausting the chamber; a gas supply section supplying a predetermined gas into the chamber; a sample stage disposed in the chamber; and an observation section observing morphological change associated with a temperature distribution in the test material tapped onto the sample stage, wherein the vacuum exhaust section and the gas supply section establish a vacuum atmosphere, an inert gas atmosphere, a reducing atmosphere or an air atmosphere in the chamber. It is preferable to include: a melting section disposed above the sample stage and transforming the test material into a molten state; and a tapping control section causing the test material transformed into a molten state by the melting section to be tapped.

### BACKGROUND OF THE INVENTION

The present invention relates to a wettability tester used to evaluate wettability of a test material in a molten state by tapping the test material in the form of liquid onto a solid substrate or a rotating roll, particularly to a wettability tester directed to tests on test materials that take on a liquid form when heated.

Today, test materials that take on a liquid form when heated, such as metals, alloys, ceramics, glass and resins, are evaluated for wettability that is one property of such materials.

The evaluation of wettability is useful for observing, for instance, bonding or adhesion between members or compatibility between a molten material and an object to which the molten material adheres in thermal spraying, casting such as die casting, or a liquid quenching, single-roll process.

For example, JP 2017-3337 A describes a wettability test device that properly conducts a wettability test in a vacuum. The wettability test device of JP 2017-3337 A includes a vacuum container; a vacuum exhaustion path and an inert gas introduction path connected to the vacuum container; a cooled TIG torch and a cooled electrode installed in the vacuum container such that an angle formed between the opposed tips thereof can be changed; a power supply applying a discharge voltage between the TIG torch and the electrode; and a test material holding means that sequentially feeds a tip of a metal test material during arc discharge generated between the TIG torch and the electrode to melt the tip, thereby forming a droplet.

JP 2017-3337 A describes the wettability test device that properly conducts a wettability test in a vacuum. In the present circumstances, it is desired to observe, in addition to a contact angle between a test material in a molten state and a solid substrate, morphological change associated with a temperature distribution in the test material at the time when the test material in a molten state is deposited to the solid substrate or a rotating roll. However, there is no such device that enables observation of, in addition to a contact angle between a test material in a molten state and a solid substrate, morphological change associated with a temperature distribution in the test material.

### SUMMARY OF THE INVENTION

An object of the present invention is to solve the problem of the conventional art and to provide a wettability tester that enables observation of, in addition to a contact angle between a test material in a molten state and a solid substrate, morphological change associated with a temperature distribution in the test material at the time when the test material in a molten state is deposited to the solid substrate or a rotating roll.

In order to achieve the above object, the present invention provides a wettability tester using a test material in a molten state, comprising: a chamber; a vacuum exhaust section exhausting the chamber; a gas supply section supplying a predetermined gas into the chamber; a sample stage disposed in the chamber; and an observation section observing morphological change associated with a temperature distribution in the test material tapped onto the sample stage, wherein the vacuum exhaust section and the gas supply section establish a vacuum atmosphere, an inert gas atmosphere, a reducing atmosphere or an air atmosphere in the chamber.

It is preferable to include: a melting section disposed above the sample stage and transforming the test material into a molten state; and a tapping control section causing the test material transformed into a molten state by the melting section to be tapped.

Preferably, the tapping control section includes a dropping control section causing the test material melted in a nozzle by the melting section to be dropped or a flow rate adjustment section causing the test material melted in the nozzle by the melting section to be continuously tapped, and the dropping control section includes: a pressurizing section applying pressure to the test material in a molten state in the nozzle; a decompression section reducing pressure inside the nozzle; and a detection section detecting dropping of the test material in a molten state from the nozzle.

For instance, for the melting section retaining and melting a test material and the dropping control section, a spherical monodisperse particle manufacturing apparatus disclosed in JP 2001-353436 A may be used. The use of the apparatus of JP 2001-353436 A makes it possible to drop droplets having less deviation in particle size. This apparatus controls the particle size and the number of particles by controlling the vibration of a diaphragm, and therefore, the material of the diaphragm is important. Meanwhile, the use of the apparatus is not favorable when a molten metal is reactive with the material of the diaphragm, and the apparatus is applicable to wettability tests of materials other than highly active metals such as titanium alloys.

Preferable examples of the melting section and the dropping control section are as follows: For the melting section retaining and melting a test material, use may be made of a nozzle integral with a crucible having at its end a hole with a diameter of 0.5 mm or more but less than 2 mm. In this case, the dropping control section includes a pressurizing section that applies pressure to a test material in a molten state retained in the nozzle, a decompressing section that reduces pressure in the nozzle, and a detection section that detects dropping of a test material in a molten state from the nozzle. In response to detection of dropping of a test material in a molten state by the detection section, the decompression section reduces the pressure in the nozzle.

The material of the nozzle can be selected from among various substances such as quartz, carbon and silicon nitride in view of workability of the material for the nozzle and reactivity with a test material. For a wettability test of a silicon alloy or the like, the use of a carbon nozzle was found to be preferable.

For the melting section, a levitation melting device disclosed, for instance, in Fuji Electric Journal Vol. 71, No. 5, pp. 264-267 may be used. When a levitation melting device is used, a reaction with a nozzle or the like would not occur. This mechanism makes it possible to reduce contamination that may occur when a highly active metal having a high melting point is melted, and the change in wettability caused by contamination can be minimized. Thus, a levitation melting device is preferred as the melting section of the wettability tester. In the case of using a levitation melting device as the melting section, exemplary dropping methods include a dropping method by means of gravity, which is caused by stopping current supply to an induction coil, and a method of dropping caused by reducing current supplied to, of upper and lower induction coils, the lower coil as disclosed in JP 3129076 B. Those droplet producing methods are advantageous for wettability tests of highly active metals having high melting points such as pure titanium and pure zirconium.

Preferably, the detection section detects dropping of the test material in a molten state from the nozzle by using brightness information acquired from an image of the test material in a molten state taken by a photographing section. A position to be detected is not limited as long as it is between the dropping control section and the sample stage. For instance, when the melting section having the nozzle and the dropping control section are provided, the detection section is disposed immediately below the nozzle, so that the pressure inside the nozzle can instantaneously be controlled. Alternatively, when the detection position is set to be close to the stage such that the detection section detects dropping of a test material in a molten state from the nozzle by using image information on the test material in a molten state as obtained from an image taken by the photographing section, the dropping condition and the pressure applied to the dropping control section can be feedback-controlled, and this is preferable.

Preferably, the sample stage includes at least one of a solid substrate and a rotating roll.

In measurement of a contact angle, the material of the solid substrate or the rotating roll is selected as the counterpart material of a test material in measuring the wettability therebetween, and accordingly, the material of the solid substrate or the rotating roll can arbitrarily be selected and changed by a user of the tester.

Preferably, the sample stage includes the solid substrate and the rotating roll, the sample stage includes an up-down movement section that moves the solid substrate up and down and a movement section that moves the rotating roll, and a direction in which the solid substrate is moved up and down and a direction in which the rotating roll is moved are perpendicular to each other.

The rotating roll is needed for simulatively testing the wettability between a device disposed in such an apparatus as a single-roll, rapidly-solidifying apparatus, a strip casting apparatus or a continuous casting apparatus and a test material in a molten state, and a roll made of copper or steel, a chromium-plated roll or the like is preferably used. Preferably, the temperature of the rotating roll is also controllable.

Preferably, the solid substrate has a flat part onto which the test material in a molten state is dropped, and at least one of a dropping distance between the flat part and the nozzle, a position of the flat part around an up-down shaft, and an inclination angle of the flat part can be changed.

It is preferable to include a temperature adjustment section keeping a temperature of the sample stage at a predetermined temperature.

Preferably, the melting section melts the test material by a high-frequency induction heating method, a resistance heating method or a radiation heating method, and it is preferable to include a temperature control section controlling the test material melted by the melting section to a predetermined temperature.

For instance, preferably, the test material is a material that takes on a liquid form when heated, and the test material is a metal, an alloy, a ceramic, glass or a resin.

Preferably, the melting section and a dropping section are collectively constituted of a spherical monodisperse particle manufacturing apparatus.

Preferably, the melting section and a dropping section are collectively constituted of a levitation melting device.

The present invention makes it possible to observe, in addition to a contact angle between a test material and a solid substrate, morphological change associated with a temperature distribution in the test material at the time when the test material in a molten state is deposited to the solid substrate or a rotating roll.

### BRIEF DESCRIPTION OF THE DRAWINGS

FIG. 1 is a schematic view showing a first example of a wettability tester according to an embodiment of the invention.

FIG. 2 is a schematic view showing a second example of the wettability tester according to the embodiment of the invention.

FIG. 3 is a schematic view showing one example of a sample stage of the wettability tester according to the embodiment of the invention.

FIG. 4 is a schematic view showing one example of a dropping control section of the wettability tester according to the embodiment of the invention.

FIGS. 5A and 5B are schematic views showing one example of dropping of a test material in a molten state in the wettability tester according to the embodiment of the invention.

FIG. 6 is a schematic view showing a third example of the wettability tester according to the embodiment of the invention.

FIG. 7 is a schematic view showing a fourth example of the wettability tester according to the embodiment of the invention.

FIG. 8 is a schematic view showing dropping of a test material in a molten state in the wettability tester in the first example of the embodiment of the invention.

FIG. 9 is a schematic view showing a temperature distribution of the test material in a molten state at dropping in the wettability tester in the first example of the embodiment of the invention.

FIG. 10 is a schematic view showing dropping of a test material in a molten state in the wettability tester in the second example of the embodiment of the invention.

FIG. 11 is a schematic view showing a temperature distribution of the test material in a molten state at dropping in the wettability tester in the second example of the embodiment of the invention.

### DETAILED DESCRIPTION OF THE INVENTION

On the following pages, a wettability tester of the present invention is described in detail with reference to the preferred embodiment shown in the accompanying drawings.

The drawings referred to below only show examples for describing the present invention, and the invention is by no means limited to those drawings.

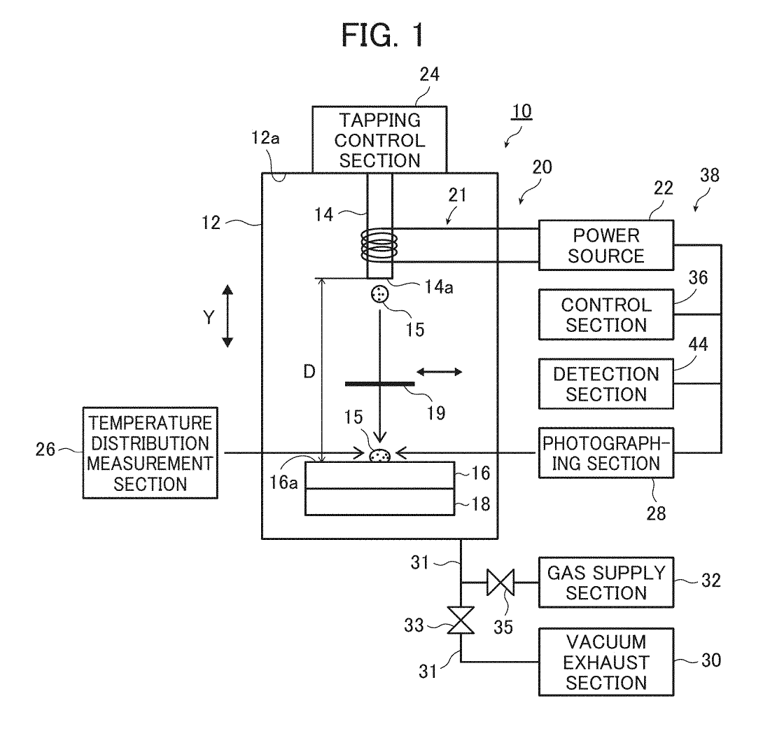

FIG. 1 is a schematic view showing a first example of a wettability tester according to an embodiment of the invention.

A wettability tester 10 shown in FIG. 1 is a test device that measures the wettability using a test material in a molten state.

The wettability tester 10 includes: a chamber 12; and a nozzle 14, a sample stage 16 and a temperature adjustment section 18 that are disposed in an interior 12a of the chamber 12. The wettability tester 10 is provided with a control section 36 controlling the constituent components and is thus controlled by the control section 36.

A wettability test is conducted in the interior 12a of the chamber 12. The chamber 12 is required to keep the state where the interior 12a is under reduced pressure and filled with a gas such as an inert gas or a reduction gas and therefore, preferably has high air tightness. The chamber 12 is for example made of stainless steel or an aluminum alloy.

The nozzle 14 is used for tapping a test material in a molten state to a sample stage and constitutes part of a melting section 20. Tapping comprises continuously supplying a test material in a molten state onto a sample stage and, in addition, intermittently supplying a test material in a molten state, in the form of a droplet for example, onto a sample stage.

The nozzle 14 is for example disposed above the sample stage 16 and serves to hold a test material in a molten state and supply the test material in a molten state as a droplet 15 onto the sample stage 16. The nozzle 14 is made of a material which is resistant to heat at a temperature of or higher than the melting point of a test material, which is nonreactive with the test material, and to which the test material does not firmly adhere. For instance, the nozzle 14 is made of such a substance as silica glass, carbon, silicon nitride or boron nitride.

The material of the nozzle 14 can be selected from among various substances such as silica glass, carbon, silicon nitride and boron nitride as above in view of workability of the material for the nozzle and reactivity with a test material. It has been confirmed that, when a test material is a silicon alloy for example, the use of a carbon nozzle is preferred.

The nozzle 14 is for example formed of a cylindrical tube. The nozzle 14 preferably has a function of retaining therein a test material in a molten state, and in this case, is formed of a cylindrical tube having a conical tip, for example.

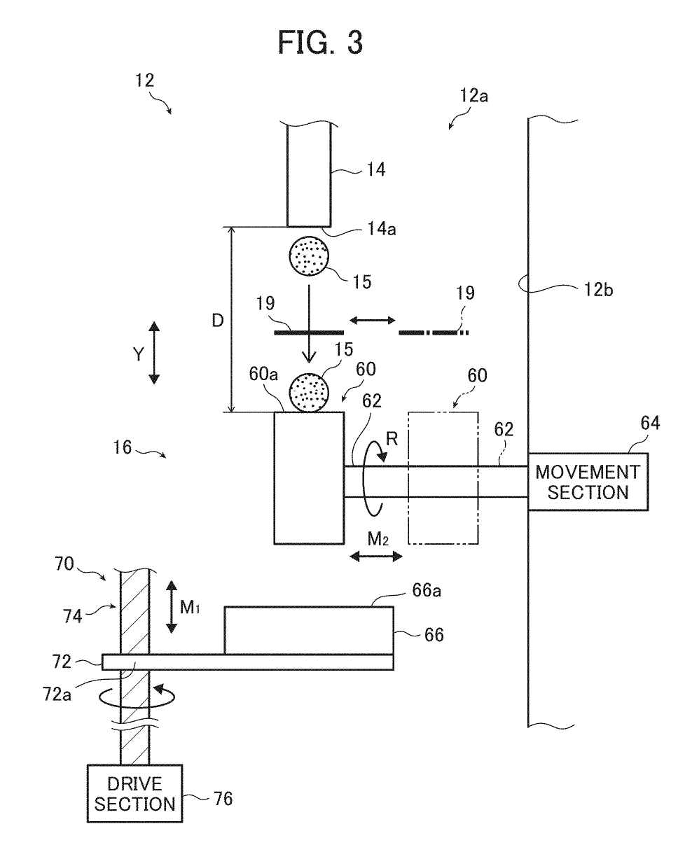

The sample stage 16 is not particularly limited in the structure as long as it can receive a test material in a molten state supplied in the form of a droplet 15 or the like, thus allowing the test material to be observed; the sample stage 16 has for example a solid substrate 66 (see FIG. 3). The solid substrate 66 has a flat part onto which a test material in a molten state is dropped in the form of a droplet 15. The sample stage 16 may be configured such that at least one of a dropping distance D between the flat part and the nozzle 14, the position of the flat part around an up-down shaft 74 (see FIG. 3), and the inclination angle of the flat part can be changed. In this case, use may be made of a known stage that is configured such that at least one of the position of the flat part in the vertical direction Y, the position of the flat part around the up-down shaft 74 (see FIG. 3), and the inclination of the flat part can be changed.

In FIG. 1, the dropping distance D between the flat part and the nozzle 14 is a distance from a tip 14a of the nozzle 14 to a surface 16a of the sample stage 16.

The temperature adjustment section 18 serves to heat the sample stage 16, for instance. For the temperature adjustment section 18, a suitable device is appropriately selected according to the heating temperature, and one example that may be used is a resistance heater.

The temperature adjustment section 18 may have other functions than heating and may serve to cool the sample stage 16 to 0° C. or lower. In this case, a Peltier device may be used for the temperature adjustment section 18, for instance. The temperature adjustment using the temperature adjustment section 18 is carried out by the control section 36, for instance.

The wettability tester 10 includes the melting section 20 that is for example disposed above the sample stage 16 in the interior 12a of the chamber 12 to melt a test material in the nozzle 14 into a molten state. The melting section 20 need not necessarily be disposed in the interior 12a of the chamber 12 as long as it is situated above the sample stage 16.

The melting section 20 is not particularly limited as long as it can transform a test material into a melting state, and any suitable device may be used according to the test material subjected to a test. One exemplary device usable as the melting section 20 is a device capable of heating a test material to a temperature of 1,600° C. or higher.

For the melting section 20, for example, a high-frequency induction heating method is employed. In this case, the melting section 20 includes a coil 21 for applying a high frequency current to a test material in the nozzle 14 and a power source 22 for applying a high frequency current at a specific frequency to the coil 21. The coil 21 is wound around the nozzle 14.

The melting section 20 may include a temperature sensor for measuring the temperature of a test material in the nozzle 14. The temperature sensor makes it possible to determine whether a test material is in a molten state or not. A measurement signal of the temperature sensor may be output to the control section 36 and, upon receipt thereof, the control section 36 may control the output of the power source 22. The control section 36 and the power source 22 together constitute a temperature control section 38. The temperature control section 38 serves to control a test material melted by the melting section 20 to a predetermined temperature.

The temperature sensor is not particularly limited as long as it can measure the temperature of a test material being subjected to induction heating, and examples thereof include a thermocouple and a radiation thermometer.

The heating method of the melting section 20 is not necessarily the high-frequency induction heating method and may be a resistance heating method or a radiation heating method. One example of the radiation heating method is an infrared radiation heating method.

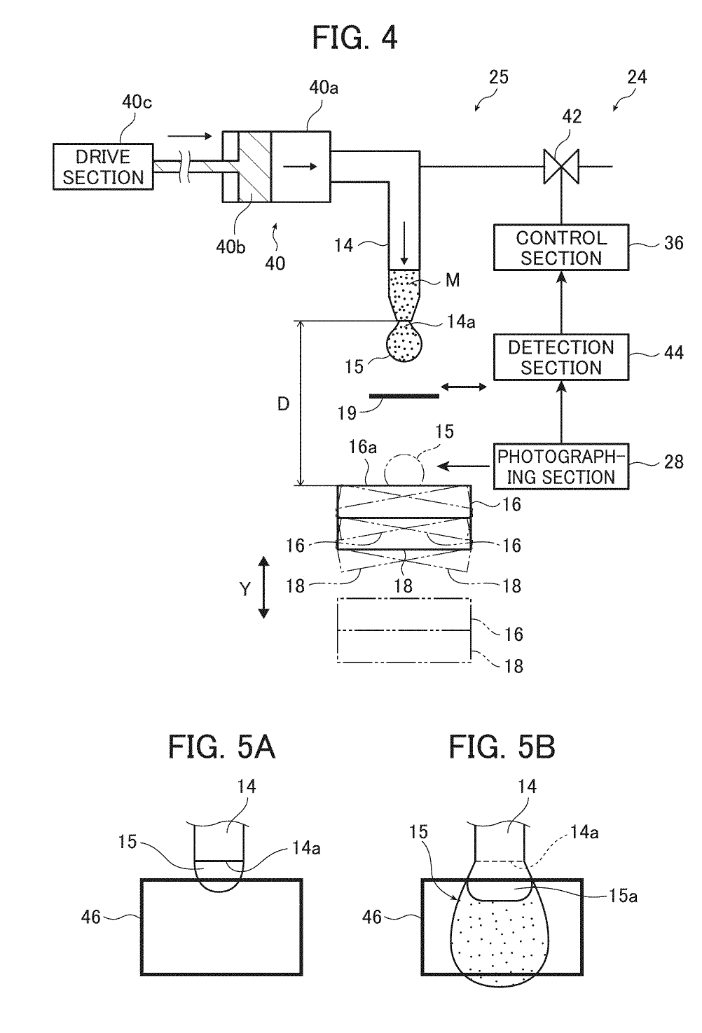

The wettability tester 10 includes a tapping control section 24 that causes a test material having been transformed into a molten state in the nozzle 14 by the melting section 20 to be tapped. The tapping control section 24 has a dropping control section 25 (see FIG. 4) that causes a test material melted in the nozzle 14 by the melting section 20 to be dropped or a flow rate adjustment section (not shown) that causes a test material melted in the nozzle 14 by the melting section 20 to be continuously tapped. The flow rate adjustment section serves to continuously supply a test material in a molten state onto the sample stage 16, more specifically, continuously supply a test material in a molten state, which is retained in the nozzle 14, onto the sample stage 16. The flow rate adjustment section may be configured to cause all of a melted test material to be tapped. In this case, all of the test material in a molten state is continuously supplied onto the sample stage 16.

The dropping control section 25 (see FIG. 4) that supplies, as a droplet 15, a test material retained in the nozzle 14 onto the sample stage 16 is described later.

The wettability tester 10 further includes: a temperature distribution measurement section 26 used to observe morphological change associated with a temperature distribution in a test material tapped onto the sample stage 16; and a photographing section 28 that photographs a test material tapped onto the sample stage 16. The temperature distribution measurement section 26 functions as an observation section. The photographing section 28 also functions as the observation section.

The temperature distribution measurement section 26 is not particularly limited as long as it can measure morphological change associated with a temperature distribution in a test material in a molten state, and one example thereof that may be used is an infrared thermography because this can measure temporal changes in cooling rate, solidification and other aspects. When an infrared thermography is used, an infrared thermography capable of measuring a temperature of 500° C. or higher is preferably used. In conventional wettability testers, even when heating to 500° C. or a higher temperature is possible, since a test material is placed on a substrate and then the temperature adjustment is carried out, a reaction between a molten alloy and the substrate proceeds, thus making it impossible to measure instantaneous wettability between the substrate and the molten alloy. The frame rate is preferably set to at least 100 f/s. Since radiant heat generated through heating of the nozzle 14 by the melting section 20 may be reflected to a test material, a heat insulator 19 is preferably disposed between the nozzle 14 and the sample stage 16 in order to measure a temperature distribution of the test material in a molten state. The heat insulator 19 is installed to be movable such that it can be moved from below the tip 14a of the nozzle 14 to another place when a droplet 15 is dropped from the nozzle 14 and moved back to the position below the tip 14a of the nozzle 14 after dropping of the droplet 15. For instance, after the supply of a test material in a molten state such as dropping of a droplet 15 is detected, the heat insulator 19 is moved to the position below the tip 14a of the nozzle 14. The movement of the heat insulator 19 is controlled by the control section 36.

The heat insulator 19 is not particularly limited as long as it can block radiant heat, and is made of, for instance, a ceramic.

The photographing section 28 is not particularly limited as long as it can photograph a test material in a molten state tapped in the form of a droplet or the like, and one example thereof is a device having a frame rate according to the dropping speed of a droplet 15 and the period of time a target phenomenon progresses.

For instance, to photograph a flat form of a droplet being dropped onto the sample stage 16, it is desired for the photographing section 28 to have a frame rate of 1,000 f/s or higher.

The frame rate of the temperature distribution measurement section 26 has its limitation, and the use of the photographing section 28 capable of high-speed photography in combination makes it possible to accurately measure changing processes of temperature distribution and shape, thus enabling measurement of the change in wettability associated with heat transfer.

A photographing range of the photographing section 28 is not particularly limited as long as it is situated between the point where the supply of a test material in a molten state starts (e.g., the tip 14a of the nozzle 14) and the sample stage 16. For instance, when the melting section 20 having the nozzle 14 and the dropping control section 25 (see FIG. 4) are provided, the photographing section 28 is disposed immediately below the nozzle 14, so that the pressure inside the nozzle 14 can instantaneously be controlled. Alternatively, when the photographing section 28 is disposed near the sample stage 16, image information on a test material in a molten state as obtained from an image taken by the photographing section 28 can be used to detect dropping of the test material in a molten state from the nozzle 14; this is preferable because the dropping condition and the pressure applied to the dropping control section can be feedback-controlled.

For the photographing section 28, a high-speed camera is used, for example. The photographing section 28 is also used for detecting dropping of a test material in a molten state from the nozzle 14. For instance, brightness is used to detect dropping of a droplet 15; thus, the photographing section 28 is not limited as long as it can acquire brightness information. Accordingly, the photographing section 28 may be one for color or monochrome photography. A high-speed camera is for example used for the photographing section 28, and the camera for use may be a color or monochrome camera.

The chamber 12 is connected via a pipe 31 and a valve 33 to a vacuum exhaust section 30 that exhausts the interior 12a. For the vacuum exhaust section 30, a suitable device is appropriately selected according to the volume of the interior 12a of the chamber 12 and a target pressure, and examples thereof include vacuum pumps such as a rotary pump and a turbomolecular pump. A rotary pump and a turbomolecular pump may be combined to form the vacuum exhaust pump 30.

The chamber 12 is also connected via the pipe 31 and a valve 35 to a gas supply section 32 that supplies a predetermined (specific) gas to the interior 12a. The gas supply section 32 includes, for example, a tank that stores an inert gas such as an argon gas or a nitrogen gas therein and a regulation valve that is used to regulate the flow rate of gas flowing from the tank. The gas supplied by the gas supply section 32 is not limited to an inert gas supplied to the interior 12a of the chamber 12 and may be a reduction gas such as a hydrogen gas or a gas that reacts with a test material (i.e., a reactive gas).

The chamber 12 is provided with a pressure sensor (not shown) for measuring the pressure in the interior 12a. A measurement signal of the pressure sensor may be output to the control section 36 and, upon receipt thereof, the control section 36 may control, for instance, the output of the vacuum exhaust section 30.

In the wettability tester 10, the interior 12a of the chamber 12 is exhausted by the vacuum exhaust section 30 with the valve 33 being opened and the valve 35 being closed, so as to achieve a preset pressure. Next, the valve 33 is closed and the valve 35 is opened so that the gas supply section 32 can supply a specific gas to the interior 12a of the chamber 12. Thus, the interior 12a of the chamber 12 can have not only a vacuum atmosphere established by the vacuum exhaust section 30 but also a preset atmosphere. For instance, by supplying an inert gas such as an argon gas or a nitrogen gas, a reduction gas such as a hydrogen gas, or a reactive gas to the interior 12a, an inert gas atmosphere, a reducing atmosphere or a reactive atmosphere can be established. The wettability tester 10 is applicable also to tests conducted in an air atmosphere.

To establish an inert gas atmosphere, a reducing atmosphere or a reactive atmosphere in the interior 12a of the chamber 12, the pressure in the interior 12a is reduced by the vacuum exhaust section 30, and then, an inert gas, a reduction gas or a reactive gas is supplied from the gas supply section 32. The controller 36 controls opening and closing of the valves 33 and 35 to switch between the connection with the vacuum exhaust section 30 and that with the gas supply section 32.

A sensor (not shown) for measuring the oxygen concentration in the interior 12a of the chamber 12 is preferably installed. The provision of such a sensor for measuring the oxygen concentration makes it possible to manage the oxygen concentration in the interior 12a of the chamber 12. In this case, the oxygen concentration can be used as an index of oxidation, thus enabling measurement of dynamic change in wettability that proceeds with the progress of oxidation as well as determination of oxygen concentration dependency of a solidification process.

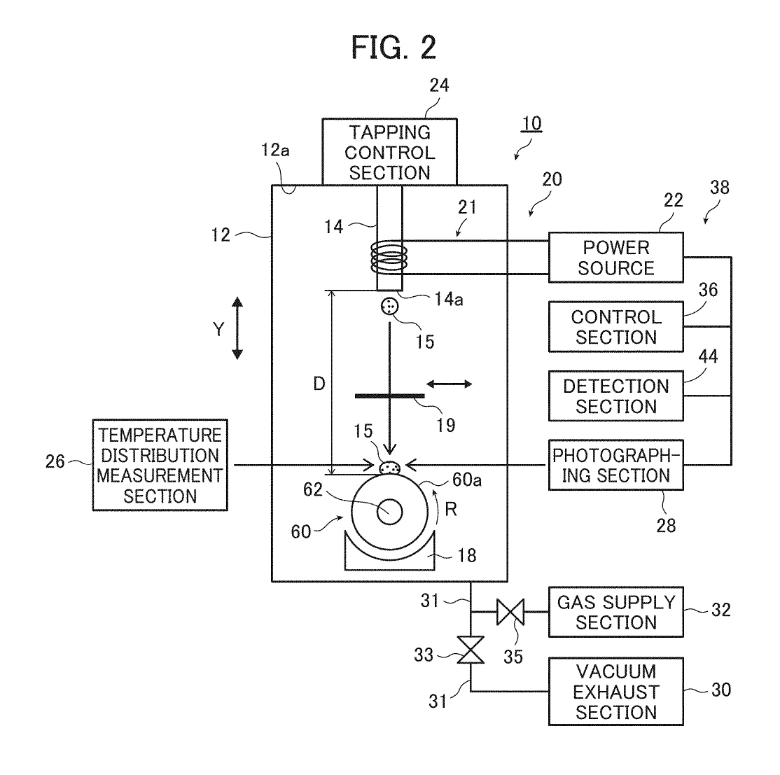

FIG. 2 is a schematic view showing a second example of the wettability tester according to the embodiment of the invention, and FIG. 3 is a schematic view showing one example of the sample stage of the wettability tester according to the embodiment of the invention.

A wettability tester 10 shown in FIG. 2 has the same structure as the wettability tester 10 shown in FIG. 1 except that its sample stage 16 is different in structure from that of the wettability tester 10 shown in FIG. 1.

The wettability tester 10 shown in FIG. 2 has a rotating roll 60 as the sample stage 16. The rotating roll 60 is constituted of a cylindrical member and has a rotary shaft 62. The rotary shaft 62 is connected to a drive section (not shown). The rotating roll 60 is driven by the drive section to rotate about the rotary shaft 62 in a direction R.

The distance between a peripheral surface 60a of the rotating roll 60 and the tip 14a of the nozzle 14 is the dropping distance D. The nozzle 14 may be configured to be movable in a vertical direction Y such that the tip 14a of the nozzle 14 can get close to or away from the rotating roll 60 and thus the dropping distance D is changeable.

However, the rotating direction is not limited to the direction R. A wettability test may be carried out with the rotating roll 60 remaining still.

The temperature of the rotating roll 60 is preferably controllable and may be high, e.g., higher than 100° C. or low, e.g., 0° C. or lower.

The wettability tester 10 is configured to have the rotating roll 60 that rotates, which makes it possible to evaluate the wettability accompanied by continuous fluidity. Further, the temperature distribution measurement section 26 can be used to observe morphological change associated with a temperature distribution in a test material at the time when the test material in a molten state is deposited to the rotating roll 60. Also in this case, the influence of oxidation can be excluded by establishing a vacuum atmosphere or an inert gas atmosphere in the interior 12a of the chamber 12. The influence of oxidation can quantitatively be evaluated by using measurement results of oxygen concentration measured by a sensor for measuring the oxygen concentration as described above. Also in a reducing atmosphere or a reactive atmosphere, the wettability accompanied by continuous fluidity can be evaluated, and in addition to a contact angle, morphological change associated with a temperature distribution in a test material at the time when the test material in a molten state is deposited to the rotating roll 60 can be observed.

As shown in FIG. 3, the sample stage 16 may be configured to have both the solid substrate 66 and the rotating roll 60. In this case, there are provided an up-down movement section 70 that moves the solid substrate 66 up and down and a movement section 64 that moves the rotating roll. A wettability test and the like are carried out not simultaneously using both of the solid substrate 66 and the rotating roll 60 but using either one thereof. An up-down direction M₁ of the solid substrate 66 and a moving direction M₂ of the rotating roll 60 are perpendicular to each other, for instance.

The rotary shaft 62 is moved in its axial direction by the movement section 64 so that the rotating roll 60 is moved toward a wall surface 12b of the chamber 12. The axial direction of the rotary shaft 62 is the moving direction M₂ of the rotating roll 60.

The solid substrate 66 is constituted of a flat plate, and a surface 66a (flat portion) thereof receives a dropped droplet 15. As with the flat part of the sample stage 16 described above, the solid substrate 66 may be configured such that at least one of the dropping distance D between the surface 66a and the nozzle (see FIG. 4) and the inclination angle of the surface 66a can be changed. The rotating roll 60 and the solid substrate 66 may be adjustable in temperature by the temperature adjustment section 18 (not shown in FIG. 3; see FIG. 1).

The up-down movement section 70 includes a holding member 72 that holds the solid substrate 66, the up-down shaft 74 that is threadedly engaged with the holding member 72 and extends in the vertical direction Y, and a drive section 76 that causes the up-down shaft 74 to rotate. The holding member 72 includes a threadedly-engaging portion 72a having a female thread formed therein. The up-down shaft 74 is threadedly engaged with the threadedly-engaging portion 72a. The drive section 76 is constituted of, for instance, a motor but may be a handle used to manually rotate the up-down shaft 74.

When the up-down shaft 74 is rotated by means of the drive section 76, the solid substrate 66 is, along with the holding member 72, moved in the up-down direction M₁. The up-down movement section 70 allows the solid substrate 66 to be situated so as not to interfere with the rotating roll 60. The dropping distance D is also changeable.

The up-down movement section 70 is not particularly limited in structure as long as it can move the solid substrate 66 in the up-down direction M₁.

The wettability tester 10 shown in FIG. 1 and the wettability tester 10 shown in FIG. 2 enable observation of, in addition to a contact angle, morphological change associated with a temperature distribution in a test material at the time when the test material in a molten state is deposited to the solid substrate or the rotating roll, thus measuring the cooling rate.

The interior 12a of the chamber 12 may have such an atmosphere as an air atmosphere, an inert gas atmosphere, an oxidizing atmosphere, a reducing atmosphere, or if a test material is reactive, a reactive atmosphere. The test temperature is not limited to normal temperature and may be high, e.g., higher than 100° C. or low, e.g., 0° C. or lower.

The dropping distance D is also changeable. As the dropping distance D is changed, collision energy of a test material in a molten state to be dropped and tapped onto the solid substrate or the rotating roll changes accordingly, so that it is possible to observe the contact angle and the cooling process under different contacting conditions. Owing to the above configuration, for instance, thermal spraying conditions can be reproduced, and in connection with thermal spraying, knowledge on manufacturing conditions and the like can be obtained accordingly.

The wettability tester 10 shown in FIG. 1 is configured to change the dropping distance D by moving the sample stage 16 in the vertical direction Y, and the wettability tester 10 shown in FIG. 2 is configured to change the dropping distance D by moving the rotating roll 60 in the vertical direction Y; however, the configuration is not limited thereto, and the dropping distance D may be changed by moving the nozzle 14 in the vertical direction Y.

A test material is a material that takes on a liquid form when heated, and exemplary test materials that may be used include metals, alloys, ceramics, glass and resins. More specific examples of a test material include Ti, Ti alloys such as TiAl, Fe alloys, Si, AlSi, FeSiB, and glass. A test material is not particularly limited as long as it has the size allowing itself to be put into the nozzle 14. A test material in a particulate, massive, wire or another form is charged and then melted by the melting section 20.

The material of the sample stage 16 (rotating roll 60, solid substrate 66) is not particularly limited and is appropriately determined according to the test material subjected to a test; exemplary materials include copper, iron, aluminum alloys and stainless steel, and rolls made of such materials and plated are also applicable.

In particular, the rotating roll 60 is needed for simulatively testing the wettability between a device disposed in such an apparatus as a single-roll, rapidly-solidifying apparatus, a strip casting apparatus or a continuous casting apparatus and a test material in a molten state, and a roll made of copper, iron or steel, a chromium-plated roll or the like is preferably used.

When thermal spraying properties or castability is evaluated, the sample stage 16 may be made of the same material or may have the same shape or surface roughness as the material, shape or surface roughness of an object to be subjected to thermal spraying or the material or shape of a mold of the casting. In measurement of a contact angle, the material of the sample stage 16 (rotating roll 60, solid substrate 66) is selected as the counterpart material of a test material in measuring the wettability therebetween, and accordingly, the material of the sample stage 16 can arbitrarily be selected and changed by a user of the tester.

FIG. 4 is a schematic view showing one example of the dropping control section of the wettability tester according to the embodiment of the invention.

Preferable examples of the melting section and the dropping control section are as follows: For the melting section retaining and melting a test material, use may be made of the nozzle 14 integral with a crucible having at its end a hole with a diameter of 0.5 mm or more but less than 2 mm. In this case, the configuration is to be that shown in FIG. 4.

The dropping control section 25 shown in FIG. 4 includes, for instance, a pressurizing section 40 that applies pressure to a test material in a molten state retained in the nozzle 14, a decompressing section 42 that reduces pressure in the nozzle 14, and a detection section 44 that detects dropping of a test material in a molten state from the nozzle 14. In response to detection of dropping of a test material in a molten state by the detection section 44, the control section 36 controls the decompression section 42 such that the decompression section 42 reduces the pressure in the nozzle 14 to, for example, the level of the pressure in the interior 12a of the chamber 12.

The dropping control section 25 can control the weight of a droplet to be dropped. As the weight of a droplet to be dropped is changed, collision energy of the droplet dropped onto the sample stage 16 changes accordingly; due to a different contacting condition, the cooling rate of the droplet changes, so that the solidifying process at the contacting interface changes. Aside from that, when the weight of a droplet to be dropped is changed, the magnitude of gravity acting on the droplet on the sample stage 16 changes accordingly, so that the shape of the droplet changes, resulting in change in the apparent contact angle; therefore, it is necessary to control the weight of a droplet to be dropped.

The pressurizing section 40 includes a cylinder 40a connected to the nozzle 14 so as to communicate therewith, a piston 40b disposed in the cylinder 40a, and a drive section 40c causing the piston 40b to linearly move in the cylinder 40a. The drive section 40c is not particularly limited in structure as long as it can cause the piston 40b to linearly move, and examples thereof include motors such as a stepper motor, and actuators utilizing pneumatic or hydraulic pressure.

When the piston 40b is moved in the cylinder 40a toward the nozzle 14, the pressure in the nozzle 14 is increased, and accordingly, the pressure to a test material M in a molten state can be increased in a non-contact manner.

The pressurizing section 40 is not limited to the structure using the piston 40b as long as it can apply pressure to the test material M in a molten state in the nozzle 14 in a non-contact and stepwise manner to thereby drop the test material M from the tip 14a of the nozzle 14. For instance, use may be made of an actuator that compresses air in the nozzle 14 to stepwise apply pressure to the test material M in a molten state.

The decompression section 42 has a solenoid valve and is installed at the nozzle 14, for example. When the solenoid valve is opened, the pressure in the nozzle 14 is released to the interior 12a of the chamber 12 and becomes the same as that in the interior 12a of the chamber 12. The pressure in the nozzle 14 is thus reduced. The opening and closing of the solenoid valve is controlled by the control section 36.

The detection section 44 detects dropping of a test material in a molten state from the nozzle 14 by using, of information on images taken by the photographing section 28, for example, brightness. Upon detection of dropping, the detection section 44 outputs a detection signal to the control section 36. Upon receipt of the detection signal, the control section 36 opens, for instance, the solenoid valve of the decompression section 42 to reduce pressure in the nozzle 14, thereby dropping only one droplet 15 of the test material M in a molten state from the nozzle 14.

FIGS. 5A and 5B are schematic views showing one example of dropping of a test material in a molten state in the wettability tester according to the embodiment of the invention.

When, in the pressurizing section 40, the piston 40b is moved in the cylinder 40a toward the nozzle 14 by means of the drive section 40c, the pressure in the nozzle 14 is increased, and accordingly, the pressure is applied to the test material M in a molten state in the nozzle 14. Consequently, part of a droplet 15 enters a photographing region 46 as shown in FIG. 5A. As the pressure in the nozzle 14 is further increased, the test material M in a molten state in the nozzle 14 is pushed out from the tip 14a of the nozzle 14, and the almost whole droplet 15 enters the photographing region 46 as shown in FIG. 5B. At this time, the brightness of a part 15a of the droplet 15 is to be high, and this fact is used to detect the droplet 15.

The detection section 44 may use the highest brightness, the average brightness or the like in the photographing region 46 of the photographing section 28, and the threshold value of brightness is set in the detection section 44 in advance.

In the wettability tester 10, the test material M in a molten state in the nozzle 14 is dropped as a droplet 15 from the tip 14a of the nozzle 14. The temperature distribution measurement section 26 measures a temperature distribution, as well as its temporal change, of the droplet 15 deposited onto the sample stage 16. Simultaneously with the measurement by the temperature distribution measurement section 26, the photographing section 28 takes an image to obtain information on morphological change.

By using the obtained temperature distribution and taken image, it is possible to, not to mention measuring the contact angle, observe the morphological change associated with a temperature distribution in the test material at the time when the test material in a molten state is deposited to the solid substrate or the rotating roll.

The temperature distribution measurement section 26 may carry out the measurement at the same time as the time when the photographing section 28 takes an image, or alternatively at the time when the control section 36 receives a detection signal from the detection section 44 and outputs a signal causing the solenoid valve of the decompression section 42 to operate.

The tapping control section 24 enables a test material in a molten state to be continuously tapped onto the sample stage 16. For instance, continuous tapping of a test material in a molten state onto the rotating roll 60 makes it possible to measure morphological change associated with a temperature distribution in a pool of the molten material formed on the rotating roll 60 which is used to simulate the liquid quenching, single-roll process, thus enabling to measure advancing and receding contact angles and the cooling rate. In addition, when a surface of a split mold for molding is fixed with glass and a test material in a molten state is continuously tapped from a sprue, this makes it possible to know fluidity and filling properties of the test material in a molten state in the mold which is used to simulate molding, as well as knowing the temporal change of temperature distribution of the test material, thus enabling to measure the cooling rate.

Next, a third example of the wettability tester is described.

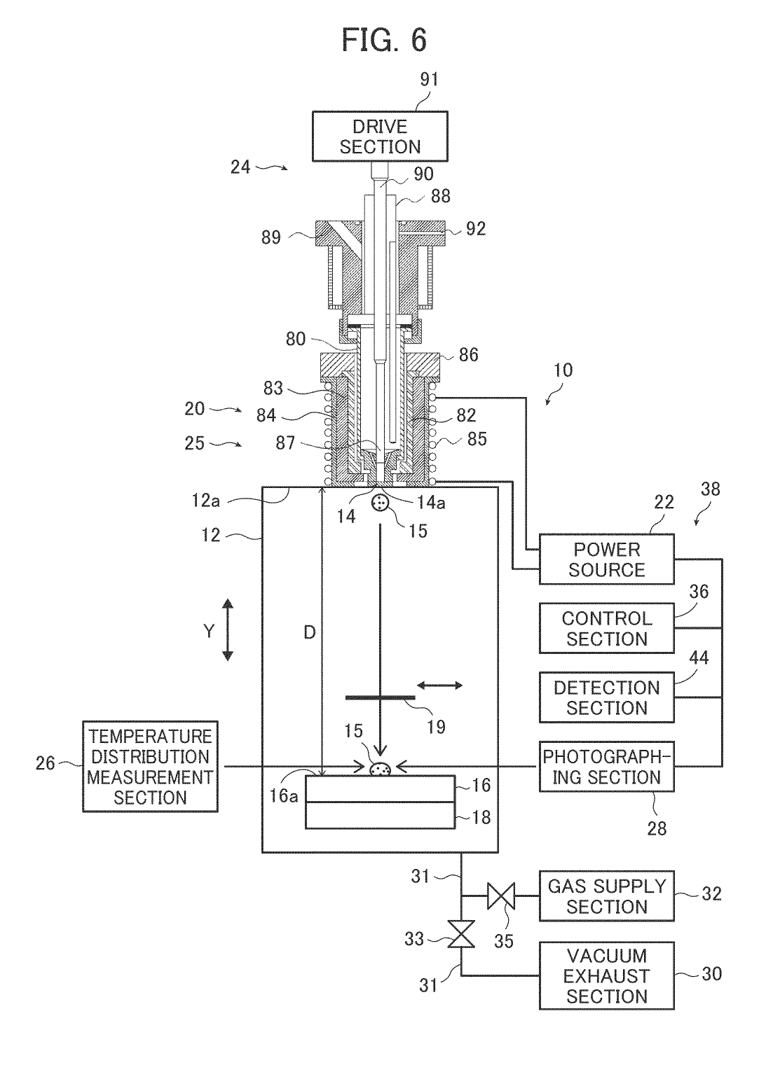

FIG. 6 is a schematic view showing the third example of the wettability tester according to the embodiment of the invention. The constituent elements corresponding to those of the wettability testers 10 shown in FIGS. 1 and 2 are assigned the same reference signs, and the detailed description thereof is omitted.

A wettability tester 10 shown in FIG. 6 has the same structure as the wettability tester 10 shown in FIG. 1 except that its melting section 20 and tapping control section 24 are different in structure from those of the wettability tester 10 shown in FIG. 1; therefore, detailed description of like components is omitted.

The wettability tester 10 shown in FIG. 6 is configured to utilize a spherical monodisperse particle manufacturing apparatus. With this configuration, the wettability tester 10 can drop droplets 15 having less deviation in particle size. In the wettability tester 10 shown in FIG. 6, the melting section 20 and a dropping section are collectively constituted of the spherical monodisperse particle manufacturing apparatus. The dropping section is provided for tapping and supplying a test material in a molten state and, in the wettability tester 10 shown in FIG. 6, constituted of the dropping control section 25.

The melting section 20 and the dropping control section 25 are collectively composed of: a carbon susceptor 82 made of carbon that is a heating element disposed outside a quartz crucible 80 to be spaced away therefrom, which crucible 80 serves to, together with the nozzle 14, retain a heated and melted material; a heat insulation material 83 disposed to surround the carbon susceptor 82; a protective tube 84 disposed outside the heat insulation material 83; and a work coil 85 for high-frequency induction heating disposed outside the protective tube 84. The work coil 85 is connected to the power source 22. A lid 86 for blocking heat is disposed above the melting section 20.

The crucible 80 can be taken out from the melting section 20. The crucible 80 is provided with a temperature sensor such as a thermocouple.

In the melting section 20 and the dropping control section 25, the work coil 85 is excited by excitation current supplied from the power source 22 to generate high frequency current, whereby carbon of the carbon susceptor 82 is heated, and the generated heat heats and melts a test material in the crucible 80 in the carbon susceptor 82. The carbon susceptor 82 has excellent uniform heating properties and is also advantageous in that high temperatures up to about 1,000° C. can be relatively easily achieved. The melting section 20 effectively works also in the case of using a material that does not generate heat even when directly applied with high frequency current.

The nozzle 14 is installed in the crucible 80 (more specifically, at a lower portion of the crucible 80) and supported at its outer periphery by the crucible 80. The nozzle 14 has a recess (not shown) in an inverted cone shape that serves to collect a test material in a molten state to the center part of the nozzle 14, and a plurality of nozzle portions (not shown) that allow a test material in a molten state to flow toward an orifice plate (not shown; described later). The nozzle portions communicate with a space (not shown) below a cylinder rod 87, and a test material in a molten state is supplied through the nozzle portions and stored in the space, i.e., cavity.

The orifice plate (not shown) having an orifice is disposed at the bottom of the nozzle 14. For the orifice plate, the most suitable material may be selected according to the test material subjected to a test. Depending on the selection of the material, the wettability of a test material in a molten state may improve. The diameter of the orifice is not particularly limited and is suitably selected according to the size of a droplet 15.

A reflector 88 is disposed above the crucible 80 for maintaining the temperature inside the crucible 80 and preventing heat from being released outside. This reflector 88 is formed from thin metal sheets that are arranged one above the other and interconnected by a wire-type connection member. The crucible 80, the nozzle 14, the reflector 88 and other components are latched on a nozzle holder 89.

The cylinder rod 87 forms a tip portion of a transmission rod 90, and the transmission rod 90 is connected at its rear end to a drive section 91. The drive section 91 is constituted of, for example, a piezoelectric actuator.

For the piezoelectric actuator, a stacked piezoelectric element is preferably used. The piezoelectric actuator is connected to, for instance, a function generator that generates a square wave at a predetermined frequency, and by applying an amplified square wave, the piezoelectric actuator enables the transmission rod 90 to be displaced at the predetermined frequency. Through the displacement of the transmission rod 90, the cylinder rod 87 is displaced accordingly, which allows a test material in a molten state in the cavity to be dropped as a droplet 15 from the tip 14a of the nozzle 14.

The transmission rod 90 and the drive section 91 together constitute the tapping control section 24.

An inert gas introduction pipe 92 is disposed above the melting section 20 so that an inert gas such as an argon gas or a nitrogen gas can be introduced into the crucible 80 therethrough. Thus, an inert gas atmosphere can be established in the crucible 80.

In the wettability tester 10 shown in FIG. 6, excitation current is supplied from the power source 22 to the work coil 85 to heat the carbon susceptor 82, which in turn heats and melts a test material in the crucible 80. Next, the drive section 91 causes the transmission rod 90 to be displaced to displace the cylinder rod 87, whereby the test material in a molten state in the cavity is dropped as a droplet 15 from the tip 14a of the nozzle 14. Thus, the droplet 15 can be deposited onto the sample stage 16. Upon receipt of a signal indicative of the drive section 91 causing the cylinder rod 87 to be displaced, the control section 36 may adjust the time to activate the temperature distribution measurement section 26 and the photographing section 28.

Next, a fourth example of the wettability tester is described.

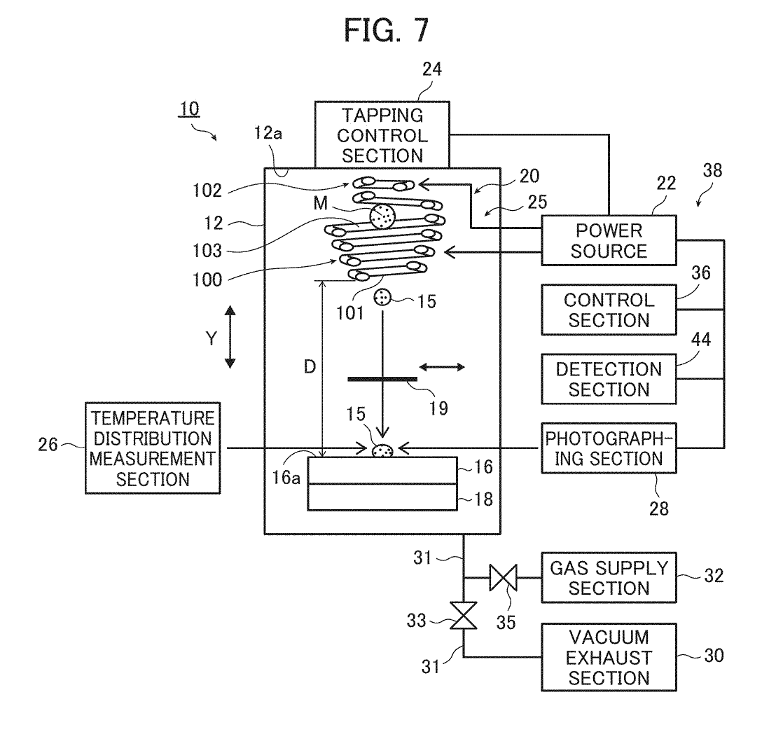

FIG. 7 is a schematic view showing the fourth example of the wettability tester according to the embodiment of the invention. The constituent elements corresponding to those of the wettability testers 10 shown in FIGS. 1 and 2 are assigned the same reference signs, and the detailed description thereof is omitted.

A wettability tester 10 shown in FIG. 7 has the same structure as the wettability tester 10 shown in FIG. 1 except that its melting section 20 and tapping control section 24 are different in structure from those of the wettability tester 10 shown in FIG. 1; therefore, detailed description of like components is omitted.

The wettability tester 10 shown in FIG. 7 is configured to use a levitation melting mechanism for melting a test material and dropping (tapping) the test material in a molten state. In the wettability tester 10 shown in FIG. 7, the melting section 20 and a dropping section are collectively constituted of a levitation melting device. The dropping section is provided for tapping and supplying a test material in a molten state and, in the wettability tester 10 shown in FIG. 7, constituted of the dropping control section 25, for example.

In the levitation melting mechanism (levitation melting device), an object to be melted makes no contact with a nozzle or the like and accordingly, no reaction occurs. This mechanism makes it possible to reduce contamination that may occur when a highly active metal having a high melting point is melted, and the change in wettability caused by contamination can be minimized. A droplet producing method using the levitation melting mechanism is advantageous for wettability tests of highly active metals having high melting points such as pure titanium and pure zirconium. Thus, the levitation melting mechanism (levitation melting device) is favorable for the melting section of the wettability tester.

Specifically, as shown in FIG. 7, the melting section 20 and the dropping control section 25 together include a first coil 100 wound to have a space inside and a second coil 102 wound to have a space inside. A melted test material M is levitated and retained in an internal space 103 formed by the first and second coils 100 and 102. For instance, a pan (not shown) for retaining a test material to be melted is disposed at an opening 101 of the first coil 100 in such a manner that the pan can be removed from the first coil 100 when the test material is melted.

The internal space 103 corresponds to the nozzle 14, and the opening 101 of the first coil 100 corresponds to the tip 14a of the nozzle 14. The melted test material M is dropped as a droplet 15 from the opening 101.

The first coil 100 serves to levitate the test material M. The second coil 102 is disposed above the first coil 100 and serves to confine the test material M to prevent the test material M from coming out of the first coil 100.

The first and second coils 100 and 102 are separately connected to the power source 22 and applied with alternating current by the power source 22, whereby the test material M is melted, and the state where the test material M is levitated in the internal space 103 formed by the first and second coils 100 and 102 is maintained.

The power source 22 is controlled by the tapping control section 24. The power source 22 is highly accurately controlled such that the test material M in a molten state is stably maintained at a predetermined temperature in the levitated state, and a control method of keeping the uniform temperature and levitation force by controlling a supplied power at a constant level is typically used.

For example, the tapping control section 24 stops application of alternating current from the power source 22 to the first and second coils 100 and 102, stops application of alternating current to the first coil 100, or reduces alternating current applied to the first coil 100, whereby the test material M in a molten state can be dropped as a droplet 15.

In the wettability tester 10 shown in FIG. 7, with a test material to be melted being placed on the pan (not shown) at the opening 101 of the first coil 100 as described above, the first and second coils 100 and 102 are separately applied with alternating current from the power source 22. As a result, the test material M is melted, and the state where the test material M is levitated in the internal space 103 formed by the first and second coils 100 and 102 is maintained. Then, as described above, the tapping control section 24 adjusts alternating current applied from the power source 22 to the first coil 100 so as to drop the test material M in a molten state as a droplet 15.

The wettability testers 10 shown in FIGS. 6 and 7 may be configured to have the rotating roll 60 as shown in FIG. 2 or both the solid substrate 66 and the rotating roll 60 as shown in FIG. 3.

The wettability tester 10 that is configured to have the sample stage 16 can, by dropping a droplet 15 to the sample stage 16, measure a contact angle of the deposited droplet 15 and evaluate static wettability. In addition, the wettability tester 10 can evaluate dynamic wettability by tilting the sample stage 16, which is called a sliding method. The sliding method enables measurement of an advancing contact angle and a receding contact angle, so that adhesion of the droplet can be evaluated. Further, it is possible to observe, in addition to a contact angle, morphological change associated with a temperature distribution in a test material at the time when the test material in a molten state is deposited to the solid substrate or the rotating roll, and the cooling rate can be measured using the temporal change of the temperature distribution.

The static wettability and dynamic wettability described above also can be evaluated with varied temperatures of the sample stage 16, and morphological change associated with a temperature distribution in a test material at the time when the test material in a molten state is deposited to the solid substrate or the rotating roll can be observed. In industrial processes involving bringing a molten material into contact with a member by, for instance, thermal spraying, casting or liquid quenching, single-roll process, the molten material and the member are typically set to have different temperatures from each other. Since wettability varies depending on the temperature of a member that is in contact with a molten material, the control of temperature of the sample stage 16 makes it possible to evaluate wettability at a given temperature which is used to simulate an industrial process involving bringing a molten material into contact with a member.

A column made of a material susceptible to high-frequency induction heating, such as carbon, is disposed on the sample stage 16, and the solid substrate and a test material are placed on the column. The column is heated by the melting section 20 which is positioned above the sample stage 16 by, for instance, the high-frequency induction heating method. Heat conducted from the heated column is used to heat the solid substrate and the test material placed on the upper portion of the column and thereby transform the test material into a molten state; thus, the contact angle of the test material in a molten state with respect to the solid substrate can be measured, and static wettability can be evaluated by a method called a sessile drop method.

Aside from that, the solid substrate having a test material thereon is disposed in the temperature adjustment section 18, and the solid substrate and the test material are heated to transform the test material into a molten state; thus, the contact angle of the test material in a molten state with respect to the solid substrate can be measured, and static wettability can be evaluated by the method called the sessile drop method. In this case, a material having a melting point lower than that of the solid substrate is selected as the test material.

In any of the foregoing cases, the influence of oxidation can be quantified by establishing a vacuum atmosphere or an inert gas atmosphere in the interior 12a of the chamber 12. The influence of oxidation can quantitatively be evaluated by using measurement results of oxygen concentration measured by a sensor for measuring the oxygen concentration as described above. In any of an air atmosphere, a reducing atmosphere and a reactive atmosphere, the static wettability and dynamic wettability described above can be evaluated, and morphological change associated with a temperature distribution in a test material at the time when the test material in a molten state is deposited to the solid substrate or the rotating roll can be observed.

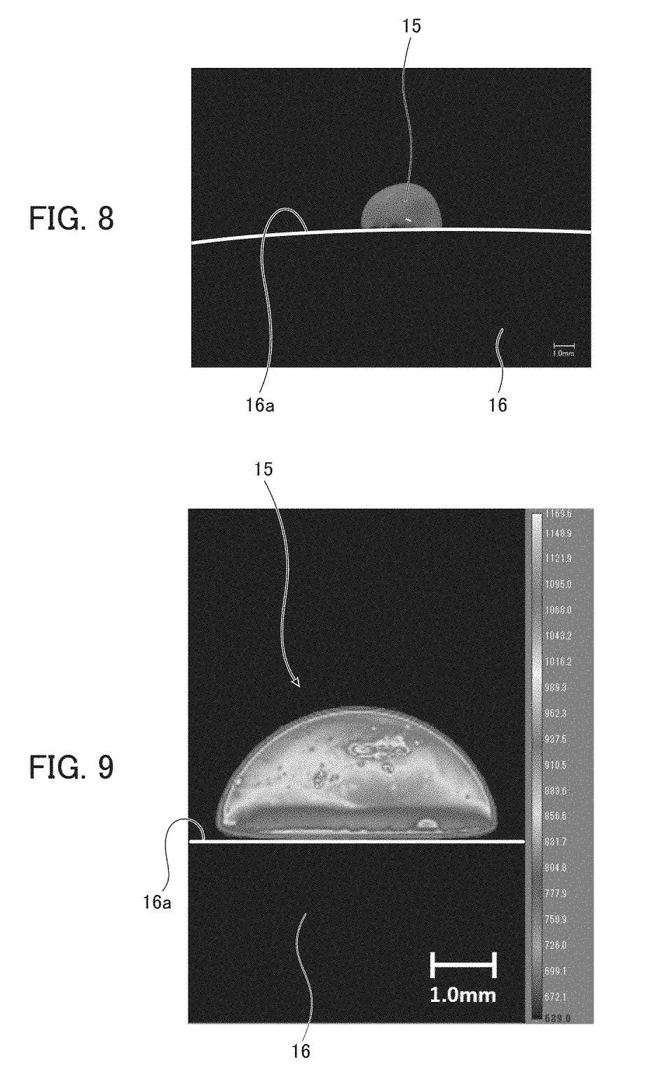

Next, specific examples of operations using the wettability tester 10 shown in FIG. 1 and the wettability tester 10 shown in FIG. 2 are described. In FIGS. 8 to 11, the constituent elements corresponding to those of the wettability testers 10 shown in FIGS. 1 and 2 are assigned the same reference signs, and the detailed description thereof is omitted.

FIG. 8 is a schematic view showing dropping of a test material in a molten state in the wettability tester in the first example of the embodiment of the invention. FIG. 9 is a schematic view showing a temperature distribution of the test material in a molten state at dropping in the wettability tester in the first example of the embodiment of the invention.

In the wettability tester 10 shown in FIG. 1, one droplet 15 can be dropped, and this can be photographed by the photographing section 28 as shown in FIG. 8. FIG. 8 shows the droplet 15 having landed on the surface 16a of the sample stage 16.

In addition, for the droplet 15, the temperature distribution measurement section 26 can obtain a temperature distribution of the landed droplet 15 as shown in FIG. 9.

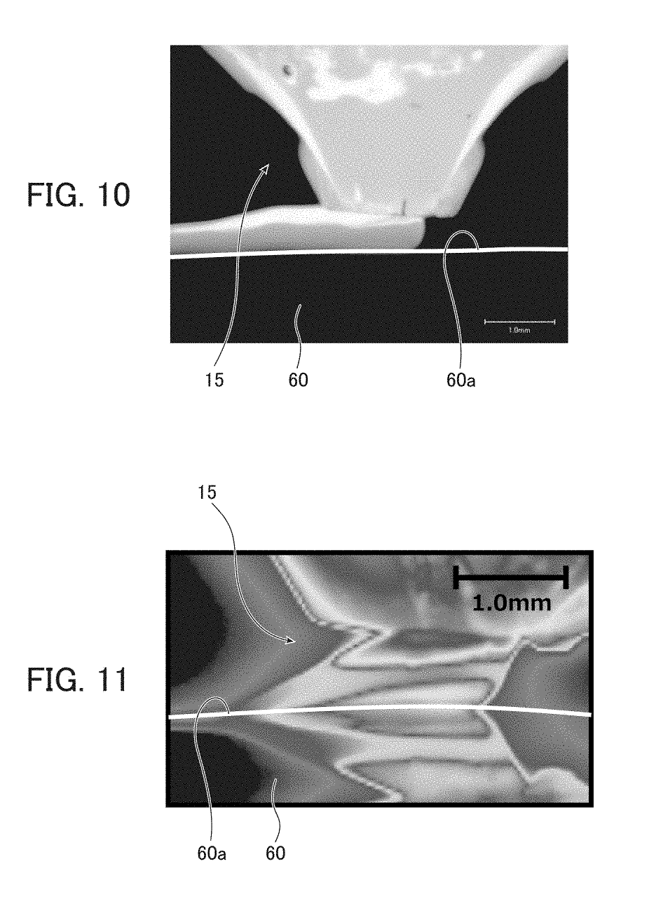

FIG. 10 is a schematic view showing dropping of a test material in a molten state in the wettability tester in the second example of the embodiment of the invention. FIG. 11 is a schematic view showing a temperature distribution of the test material in a molten state at dropping in the wettability tester in the second example of the embodiment of the invention.

The wettability tester 10 shown in FIG. 2 has the rotating roll 60. One droplet 15 can be dropped onto the peripheral surface 60a of the rotating roll 60 that is rotating, and this can be photographed by the photographing section 28 as shown in FIG. 10. FIG. 10 shows the droplet 15 having landed on the peripheral surface 60a of the rotating roll 60.

In addition, the temperature distribution measurement section 26 can obtain a temperature distribution of the droplet 15 being in contact with the peripheral surface 60a of the rotating roll 60 that is rotating, as shown in FIG. 11.

Thus, the wettability tester shown in FIG. 1 and the wettability tester shown in FIG. 2 enable observation of not only a contact angle but also morphological change associated with a temperature distribution in a test material at the time when the test material in a molten state is deposited to the solid substrate or the rotating roll.

The present invention is basically configured as described above. While the wettability tester of the invention has been described above in detail, the invention is by no means limited to the foregoing embodiment and it should be understood that various improvements and modifications are possible without departing from the scope and spirit of the invention.

What is claimed is:

1. A wettability tester using a test material in a molten state, comprising:
a chamber;
a vacuum exhaust section exhausting the chamber;
a gas supply section supplying a predetermined gas into the chamber;
a sample stage disposed in the chamber; and
an observation section observing morphological change associated with a temperature distribution in the test material tapped onto the sample stage,
wherein the vacuum exhaust section and the gas supply section establish a vacuum atmosphere, an inert gas atmosphere, a reducing atmosphere or an air atmosphere in the chamber.

2. The wettability tester according to claim 1, including:
a melting section disposed above the sample stage and transforming the test material into a molten state; and
a tapping control section causing the test material transformed into a molten state by the melting section to be tapped.

3. The wettability tester according to claim 2,
wherein the tapping control section includes a dropping control section causing the test material melted in a nozzle by the melting section to be dropped or a flow rate adjustment section causing the test material melted in the nozzle by the melting section to be continuously tapped,
the dropping control section including:
a pressurizing section applying pressure to the test material in a molten state in the nozzle;
a decompression section reducing pressure inside the nozzle; and
a detection section detecting dropping of the test material in a molten state from the nozzle.

4. The wettability tester according to claim 3,
wherein the detection section detects dropping of the test material in a molten state from the nozzle by using brightness information acquired from an image of the test material in a molten state taken by a photographing section.

5. The wettability tester according to claim 1,
wherein the sample stage includes at least one of a solid substrate and a rotating roll.

6. The wettability tester according to claim 3,
wherein the sample stage includes at least one of a solid substrate and a rotating roll.

7. The wettability tester according to claim 5,
wherein the sample stage includes the solid substrate and the rotating roll,
wherein the sample stage includes an up-down movement section that moves the solid substrate up and down and a movement section that moves the rotating roll, and
wherein a direction in which the solid substrate is moved up and down and a direction in which the rotating roll is moved are perpendicular to each other.

8. The wettability tester according to claim 6,
wherein the solid substrate has a flat part onto which the test material in a molten state is dropped, and at least one of a dropping distance between the flat part and the nozzle, a position of the flat part around an up-down shaft, and an inclination angle of the flat part can be changed.

9. The wettability tester according to claim 1, including: a temperature adjustment section keeping a temperature of the sample stage at a predetermined temperature.

10. The wettability tester according to claim 2, including: a temperature adjustment section keeping a temperature of the sample stage at a predetermined temperature.

11. The wettability tester according to claim 2,
wherein the melting section melts the test material by a high-frequency induction heating method, a resistance heating method or a radiation heating method,
the wettability tester including: a temperature control section controlling the test material melted by the melting section to a predetermined temperature.

12. The wettability tester according to claim 1,
wherein the test material is a material that takes on a liquid form when heated.

13. The wettability tester according to claim 2,
wherein the test material is a material that takes on a liquid form when heated.

14. The wettability tester according to claim 12,
wherein the test material is a metal, an alloy, a ceramic, glass or a resin.

15. The wettability tester according to claim 2,
wherein the melting section and a dropping section are collectively constituted of a spherical monodisperse particle manufacturing apparatus.

16. The wettability tester according to claim 2,
wherein the melting section and a dropping section are collectively constituted of a levitation melting device.
